(19) United States
(12) Patent Application Publication
(10) Pub. No.: US 2018/0184639 A1
(43) Pub. Date: Jul. 5, 2018

(54) APPARATUS FOR INCAPACITATING PESTS

(71) Applicant: Demetrios Nasoulis, Dacula, GA (US)

(72) Inventor: Demetrios Nasoulis, Dacula, GA (US)

(21) Appl. No.: 15/397,943

(22) Filed: Jan. 4, 2017

(51) Int. Cl. A01M 19/00; A01D 7/00; H05C 1/00

(52) U.S. Cl. CPC A01M 19/00; H05C 1/00; A01D 7/00

(57) ABSTRACT

The present invention is directed to an apparatus which facilitates a user to concurrently perform two functions: (1) incapacitating a snake or other pest while (2) raking leaves, as well as a method for doing the same.

### BACKGROUND OF THE PRESENT INVENTION

Snakes often frequent areas occupied by humans or domestic animals, such as in a person's yard. Particularly venomous varieties, such as rattlesnakes and copperheads, are also a health risk to people and animals. Even non-venomous varieties of snakes are often considered to be a nuisance, and people generally dislike coming in contact with them.

In most instances when a user is confronted with an unwanted snake in their yard, the user either avoids the animal or attempts to kill or incapacitate it with an appropriate tool, such as a shovel. This method, however, is both ineffective and potentially dangerous to the user. The shovel is also unlikely to be in the user's immediate vicinity when encountering the snake.

Currently known methods for killing or incapacitating snakes involve traps (stationary or mobile) or severing devices. Stationary traps, which must be placed in an area in which snakes are known to frequent, lure snakes and keep them in an enclosed area. After a snake is caught within one of these devices, the user must still handle and relocate the trapped, active and aware snake and transport it to another location for release. Similarly, mobile traps, such as the trap of U.S. Pat. No. 6,684,562, requires the user to find, trap, and relocate the active, aware, and possibly dangerous animal to another location.

Severing devices (i.e., any device capable of severing a snake) pose an even greater risk to the user. When the user attempts to kill or incapacitate the snake with a severing device, such as the device described in US 2015/0264916, or with a similarly repurposed tool such as a shovel, the user has a strong likelihood of agitating the snake. The user also has to be relatively close to the snake, as this method requires the user to maintain a position at a high angle vertically above the snake in order to generate an appropriate amount of force. Such a position invariably forces the user into a horizontal position in close proximity to the snake. Even worse, now that the snake has been agitated, it may be compelled to attack the user.

These current known methods are also not ideal because they are difficult to successfully operate.

Stationary traps are difficult to operate in that a user must know the location in which snake(s) frequent(s) and wait for a snake to come to the trap. As such, these devices are not suitable for unexpected encounters with a snake.

Mobile traps are also difficult to successfully operate in that the snake, a quick and agile animal, must be corralled in a net, wire, or hook of the device. Severing devices, such as shovels, are also difficult to operate in that a user must first self-position at a high angle above the snake, and then attempt to strike the agile animal before it evades the blow.

In addition a user is unlikely to be carrying one of the aforementioned devices unless they are actively trying to trap or incapacitate a snake.

### BRIEF DESCRIPTION OF THE PRESENT INVENTION

The apparatus of the present invention (the “Snake Rake”) solves the problem of safely and easily eliminating unwanted snakes that are encountered by a user when a user is raking leaves. The Snake Rake is intended to safely incapacitate a snake, so a user can either relocate the snake or dispose of the snake as needed. The Snake Rake is generally comprised of (a) a “rake” component (the “body”) consisting of a rake head having tines that extend outward from a preferably triangular, trapezoidal or semi-circular shaped frame at one end, a mounting means for an attached handle at the distal end of the rake component, with a handle attached to said mounting means, and with each tine of the rake head having a “tooth” at the end opposite of the frame, with each tooth positioned at a downward angle′relative to a horizontally oriented handle, integrated with (b) an “electroshock” component comprising a high voltage means coupled to a plurality of electrodes (with at least one positively chargeable electrode and at least one negatively chargeable electrode), said electrodes being located at the ends of one or more of the teeth.

The high voltage means preferably comprises an electronic circuit which may be housed within the body of the Snake Rake, and/or otherwise attached to the body of the Snake Rake. The electronic circuit carries out the operation of converting voltage from a power source to a voltage level capable of electrocuting a snake or other pest when the snake or other pest comes in contact or in close proximity to a positively charged electrode and a negative charged electrode.

The user would activate the electroshock component of the Snake Rake by activating a master switch, said activation causing the electronic circuit to deliver voltage capable of electrocuting a snake or other pest to the electrodes and therefore to the snake. When a snake or other pest comes in contact with both a positively charged electrode and a negatively charged electrode, the circuit becomes closed and an electric shock would be delivered to the animal.

As the Snake Rake also serves as a typical garden rake, and snakes are often encountered by a user while the user is raking their leaves (as the leaves provide a convenient cover for snakes), it is beneficial that the user will have the Snake Rake in their possession when they encounter the animal.

The Snake Rake also provides a benefit over the prior art in that a target snake does not have to be seen in order to incapacitate the snake, as the teeth of the Snake Rake can be put to the ground through leaves, grass or other covering agents in order to make contact with a snake.

The electrodes of the Snake Rake are located at the ends of one or more of the teeth of the device, which are positioned at downward angle relative to a horizontally oriented handle. This attribute provides a great improvement over the prior art in that it allows the user to pick up the snake after it is incapacitated after receiving the electric shock. While a snake is stunned, the user is able to inspect the snake, and if deemed a “good” snake (non-venomous, rids yard of mice, etc.) they may pick up the snake with the rake held so that the teeth are facing up (relative to a horizontally oriented handle), and the user can subsequently relocate the snake. Upon inspection, if the snake is classified as “undesirable”, the user may pick up the stunned snake in the same manner previously mentioned, and dispose of it properly, or give it to the local government animal control authorities.

The tines of the Snake Rake are also preferably flexible at the points where said tines meet the frame, allowing the tines to be temporarily flexed in an upward or downward position (in response to a downward or upward force, respectively) relative to a horizontally oriented handle. This attribute allows the user of the Snake Rake to strike the snake even in uneven terrain. For example, in areas where one or more of the tines may be obstructed by a small object such as a small rock or exposed tree root, the user may still be able to make contact with the snake with the unobstructed tines, as the obstructed tines will move in an upward direction due to the object.

In addition, the downward angled teeth and flexible nature allow the Snake Rake to be used for raking and to collect and move leaves on even or uneven surfaces.

### DESCRIPTION OF THE FIGURES

FIG. 1 depicts a perspective view of the apparatus of the present invention.

FIG. 2 depicts a left side view of the apparatus of the present invention.

FIG. 3 depicts a perspective view of the apparatus of the present invention, with the tines flexing upwards and downwards at their respective junctures with the frame.

FIG. 4 depicts a diagram of the electrical components in a preferred embodiment of the present invention.

### DETAILED DESCRIPTION OF A PREFERRED EMBODIMENT

The present invention is particularly directed to a multi-purpose device, including the purpose of delivering a high voltage shock to a snake or small pest with which it come in contact. The shock is delivered to incapacitate the animal, yet remain safe to the holder of the device. That is, the present invention is directed to an electrified rake, where the electric current is triggered by contact with an animal.

The Snake Rake is generally comprised of (a) a “rake” component (the “body”) integrated with (b) an “electroshock” component.

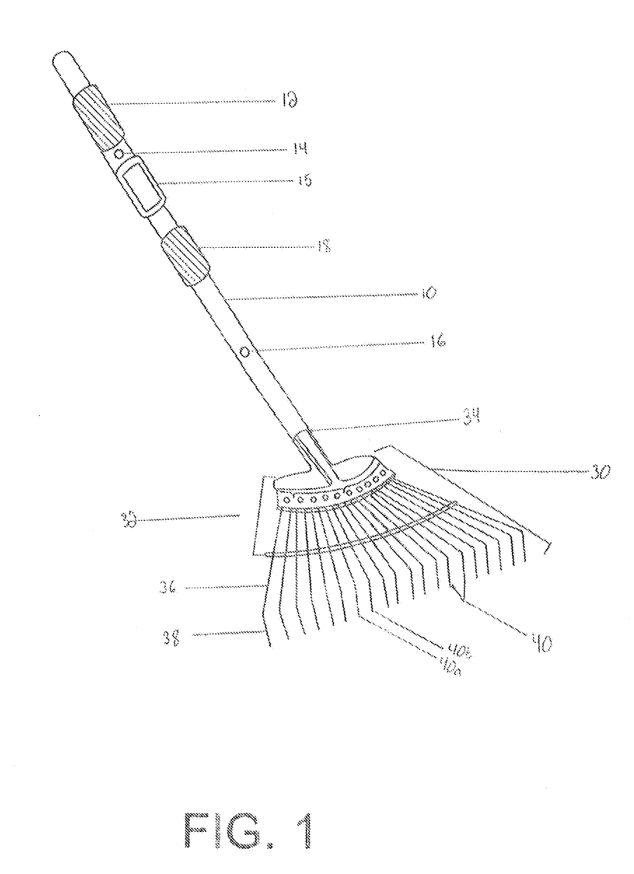

FIG. 1 depicts an embodiment of the apparatus of the present invention. The rake component of the present invention includes a handle 10 attached to a rake head 30. Rake head 30 is comprised of a preferably triangular, trapezoidal or semi-circular shaped frame 32, with one end of a frame 32 attached to a handle 10 through some mounting means 34, with outwardly extending tines 36 at the other end of a frame 32. Each of these tines has a tooth 38, which is bent at a downward angle at the end opposite of a handle 10. The “electroshock” component comprises a high voltage means coupled to a plurality of electrodes 40 (with at least one positively charged electrode 40a and at least one negatively charged electrode 40b), said electrodes 40 being located at the ends of one or more of teeth 38.

In the preferred embodiment of the invention, a handle 10 of the Snake Rake includes an upper grip piece 12 at or near the “top” of a handle 10, and a rake head 30 at the “bottom” of a handle 10.

The Snake Rake also contains a master switch 14, which is preferably located at or near an upper grip 12 piece of the body. Master switch 14 can be put in an “on” or “off” position by the user to activate or deactivate the electroshock element. When master switch 14 in the “on” position, a circuit is potentially completed but only when a positively charged electrode 40a and a negatively charged electrode 40b come in contact with a snake or other pest, and consequently, a shock is administered to the animal.

In a preferred embodiment of the present invention, master switch 14 is protected, such as by cover, so that master switch 14 is recessed to prevent accidental shocking if the Snake Rake is dropped or the master switch area accidently comes in contact with a hard surface. In another embodiment, master switch 14 may be encased, for example, in a hinged cover in order to prevent accidental shocking.

The term master switch 14 as used herein may also include some other activation means such as a trigger, button, knob, or other similar means.

The Snake Rake may also contain a safety mechanism 16 that must be activated in order for master switch 14 to generate an electrical impulse. Safety mechanism 16 may be in the form of another switch, lever, knob, or button, or some other commonly used safety mechanism. That is, a safety mechanism 16 is provided to turn the high voltage means on and off, with a master switch 14 being provided to enable and disable the electrical components as desired.

In a preferred embodiment of the present invention, handle 10 is formed of one or more of fiberglass, plastic, wood covered with rubber, or some other non-electrically conductive material, and is approximately five feet long. In different embodiments of the invention, the length of handle 10 can vary by model based on need. The length of handle 10 may also be adjustable, such as through the use of two telescopic tubes, the smaller diameter tube being an extrusion.

Handle 10 may also contain a lower grip piece 18. The user, when operating the Snake Rake, would preferably have one hand on upper grip piece 12, and the other hand on lower grip piece 18. Lower grip piece 18 is located closer to the upper grip 12 piece than to rake head 30. Upper grip piece 12 and lower grip piece 18 are preferably made of a non-electrically conductive material, such as but not limited to rubber, foam, plastic, and may be made out of different materials as one another or of the same material. These materials serve the purpose of insulating the user from any electric shock generated by the Snake Rake, as well as providing the user with a comfortable mechanism by which to grip and operate the Snake Rake.

Rake head 30 includes tines 36 that extend outward from a preferably triangular, trapezoidal or semi-circular shaped frame 32 at one end, and mounting means 34 for an attached handle 10 at the other end, with a handle 10 attached to said mounting means 34. Tines 36 are formed, at least in part, of a conductive material such as, but not limited to stainless steel, and may be insulated using some non-electrically conductive material, such as but not limited to fiberglass, plastic, or rubber.

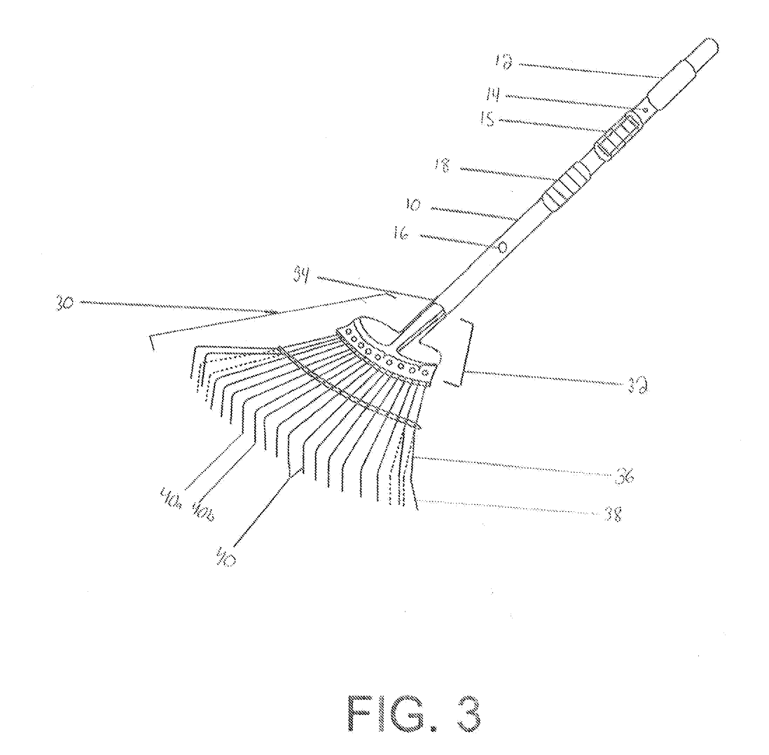

As shown in FIG. 3, each tine 36 is also preferably flexible at its juncture with the frame 32, allowing tines 36 to be temporarily flexed in an upward or downward position (in response to a downward or upward force) relative to a horizontally oriented handle 10.

Tines 36 may be close together (approximately 1 cm apart at the widest point) in order to enable users to catch small snakes or other relatively small pests. Tines 36 may also be relatively far apart (approximately 5 or more cm apart at the widest point) if the user does not need to catch small snakes or other relatively small pests.

In a preferred embodiment, rake head 30 consists of approximately twenty tines 36, each approximately three millimeters wide, and approximately two to four cm apart at its widest point. In this preferred embodiment, rake head 30 is approximately two feet wide and one foot long. A rake head 30 of this size helps ensure that a fast moving snake cannot escape.

Each tine 36 of a rake head 30 contains a tooth 38 at the end opposite of a frame 32, with each tooth 38 positioned at downward angle relative to a horizontally oriented handle 10.

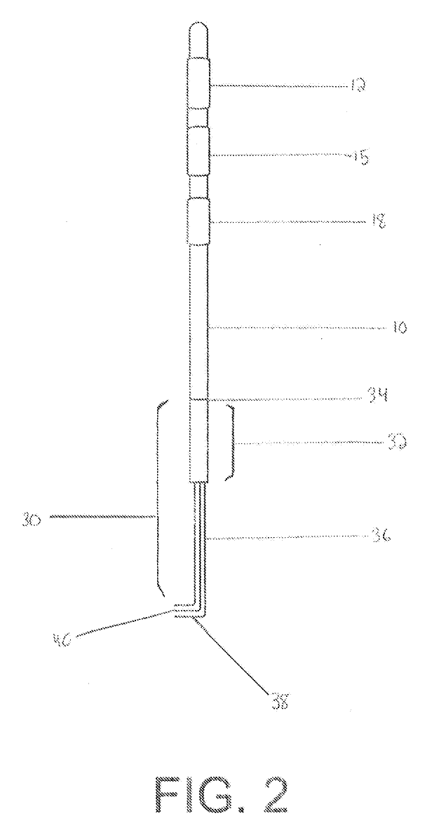

FIG. 2 depicts a side plan view of the apparatus of the present invention. As shown in this figure, the angle between a downward angled tooth 38 and rake head 30 is approximately fifteen to one-hundred-sixty-five degrees, and preferably approximateiy ninety degrees.

Teeth 38 are formed, at least in part, of a conductive material such as, but not limited to stainless steel, and may be insulated using some non-electrically conductive material, such as but not limited to fiberglass, plastic, or rubber. One or more teeth 38 contain one or more electrodes 40 at an end.

The Snake Rake contains at least one positively chargeable electrode 40a and at least one negatively chargeable electrode 40b. In a preferred embodiment, each tooth contains one electrode 40, with alternating, teeth having a pattern of positively chargeable electrodes 40a to negatively chargeable electrodes 40b. Positively chargeable electrodes 40a and negatively chargeable electrodes 40b may also be distributed in a different pattern or randomly throughout teeth 38. In another embodiment, each tooth 38 contains both a positively chargeable electrode 40a and a negatively chargeable electrode 40b, with some non-electrically conductive material, such as but not limited to fiberglass, plastic, or rubber acting as a divider between each electrode 40.

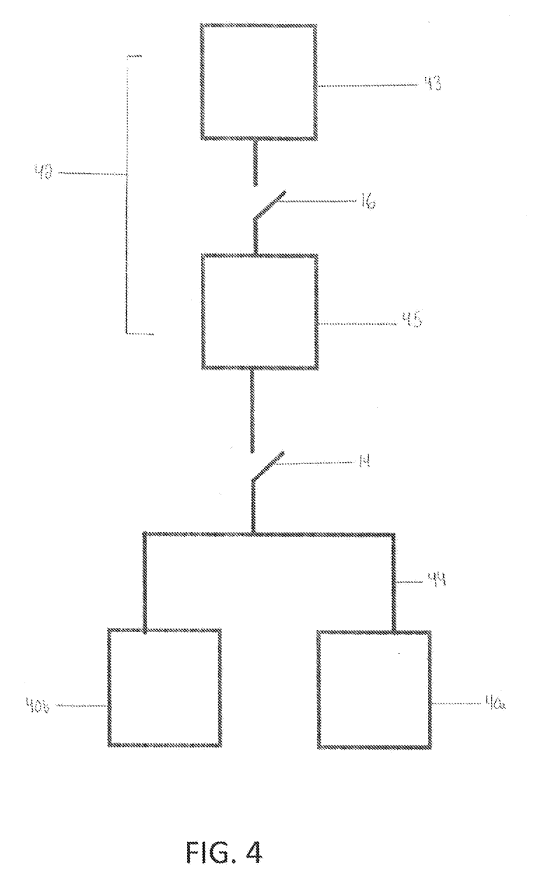

FIG. 4 depicts a diagram of the electrical components in a preferred embodiment of the present invention. In a preferred embodiment of the present invention, the electrical components consist of a master switch 14, voltage means 42 (including a power source 43 and a capacitor 45), wiring 44, and electrodes 40.

The Snake Rake may utilize flex circuitry, in addition to or rather than using conventional insulated wires 44. Flex circuitry utilizes thin, flexible plastic sheet material with conductive material imprinted or otherwise formed thereon. Such flex circuitry is conventional, and is used in various industries to provide good reliability and durability even when exposed to vibration and other forces.

Some of the electrical components of the present invention may be contained within a housing element 15 on the body of the Snake Rake. For example, a power source 43 and/or a capacitor 45 may be located within said housing 15. Some of the electrical components may be located within the body of the Snake Rake. For example, insulated wiring 44 may be located inside a handle 10 and/or rake head 30.

A power source 43 may be a disposable battery, or a rechargeable battery pack, where the rechargeable battery pack may be recharged through a standard 120V or 240V electrical outlet. The Snake Rake may also come with a charging unit, on which the Snake Rake can charge while not being in use. The Snake Rake may also contain solar cells, so that the rechargeable battery unit may be recharged when the solar cells are exposed to sunlight.

When encountering a snake or other pest, the user grasps the Snake Rake, with one hand on upper grip piece 12, and one hand on lower grip piece 18, just as they would when raking. From a safe distance, the user can reach out and make contact with the snake with the electrodes, activate the master switch, and shock the snake.

The user of the Snake Rake actuates the electrical components by turning the safety mechanism switch 16 to the active position when it appears that electrical stun capability may be needed.

At that point, the user activates a master switch 14, and an electric current produced by a voltage means 42 travels through wiring 44 to electrodes 40. When a snake or other small pest comes in contact with at least one positively charged electrode 40a, and at least one negatively charged electrode 40b, the circuit is closed, and an electric shock is delivered to the animal. In a preferred embodiment, the Snake Rake administers a shock of about three thousand to four thousand volts and less than 0.5 amperes. This current is sufficient to shock and incapacitate a snake up to five feet long or another pest between one and three feet long.

While the present invention is being referred to herein as the “Snake Rake,” this moniker is in no way intended to limit or otherwise restrict the scope of the invention. The present invention, as described herein, when used as an electroshock device, is capable of being used on any number of animals, not just snakes. Likewise, the device of the present invention, when used as a hand tool, may serve other purposes besides as a rake.

Similarly, while the invention has been described with reference to one or more embodiments, it is to be understood that these embodiments are merely illustrative of the principles of the invention. Accordingly, the embodiments described herein should be considered as exemplary, and not limiting.

1. An apparatus for incapacitating pests upon contact while raking, said apparatus comprising:
a handle;
an activation means;
a current delivery means;
a framed rake head comprising a plurality of tines that extend outwardly, each tine further comprising at least one angled tooth directing away from said handle;
a positively chargeable electrode located at the end of said tooth;
a negatively chargeable electrode located at the end of said tooth;
wherein an electric current is generatable between said positively chargeable electrode and said negatively chargeable electrode upon said electrodes' contact with a pest, said electric shock being sufficient to incapacitate said pest.

2. The apparatus of claim 1 wherein said tines can be flexed relative to said frame.

3. The apparatus of claim 1 wherein said frame is generally triangular.

4. The apparatus of claim 1 wherein said frame is generally trapezoidal.

5. The apparatus of claim 1 wherein said frame is generally semi-circular.

6. The apparatus of claim 1 wherein said positively chargeable electrode and said negatively chargeable electrode are located on the same tooth.

7. The apparatus of claim 1 wherein said positively chargeable electrode and said negatively chargeable electrode are located on adjacent teeth.

8. The apparatus of claim 1 wherein each tooth comprises a positively chargeable electrode and a negatively chargeable electrode.

9. The apparatus of claim 1 wherein each tooth comprises one or more electrodes.

10. The apparatus of claim 1 wherein adjoining teeth alternate positively chargeable and negatively chargeable electrodes.

11. The apparatus of claim 1 wherein the angle of said angled tooth is in the range of 15 to 165 degrees.

12. The apparatus of claim 1 wherein the angle of said angled tooth is approximately 90 degrees.

13. The apparatus of claim 1 wherein said apparatus utilizes flex circuitry.

14. A method of manufacturing an apparatus for incapacitating pests comprising the steps of:
formulating a handle from a non-electrically conductive material;
attaching said handle to a framed rake head through a mounting means, said framed rake head further comprising a plurality of tines that extend outwardly, each tine further comprising at least one downward angled tooth, a positively chargeable electrode located at the end of at least one of said teeth, and a negatively chargeable electrode located at the end of at least one of said teeth;
implementing a current delivery system wherein an electric current is generatable at, the positively chargeable electrode and the negatively chargeable electrode upon said electrodes' contact with an animal, said electric shock being sufficient to incapacitate said animal.

15. The method of claim 14 wherein said tines can be flexed relative to said frame.

16. The method of claim 14 wherein a positively chargeable electrode and a negatively chargeable electrode are located on the same tooth.

17. An electrically adapted rake comprising:
a handle;
an activation means;
a current delivery means;
a framed rake head comprising a plurality of tines that extend outwardly, each tine further comprising at least one angled tooth directing away from said handle;
a positively chargeable electrode located at the end of said tooth;
a negatively chargeable electrode located at the end of said tooth;
wherein an electric current is generatable between the positively chargeable electrode and the negatively chargeable electrode upon said electrodes' contact with a pest, said electric shock being sufficient to incapacitate said pest.

18. The electrically adapted rake of claim 17 wherein said tines can be flexed relative to said frame.

19. The electrically adapted rake of claim 17 wherein adjoining teeth alternate positively chargeable and negatively chargeable electrodes.

20. The electrically adapted rake of claim 17 wherein the angle of said angled tooth is in the range of 15 to 165 degrees.
